(19) United States
(12) Patent Application Publication
(10) Pub. No.: US 2008/0226352 A1
(43) Pub. Date: Sep. 18, 2008

(54) Process cartridge and image forming apparatus

(76) Inventors: Kimihiro Tanaka, Osaka (JP); Tatsuo Fukushima, Hyogo (JP); Toru Hanashima, Ibaraki (JP)

Correspondence Address: HARNESS, DICKEY & PIERCE, P.L.C., P.O. BOX 8910, RESTON, VA, 20195, US

(21) Appl. No.: 12/071,350

(22) Filed: Feb. 20, 2008

(30) Foreign Application Priority Data
Mar. 14, 2007 (JP) 2007-065252

(51) Int. Cl. G03G 15/08

(52) U.S. Cl. 399/263

(57) ABSTRACT

When starting driving of an agitating unit or a developing roller in an image forming apparatus, rotation speed of one or both of the agitating unit and the developing roller is raised in a stepwise manner until the agitating unit and the developing roller attain a steady rotation speed. When stopping the driving of the agitating unit or the developing roller, the rotation speed is lowered in a stepwise manner until completion of stop of the driving.

### CROSS-REFERENCE TO RELATED APPLICATIONS

The present application claims priority to and incorporates by reference the entire contents of Japanese priority document 2007-065252 filed in Japan on Mar. 14, 2007.

### BACKGROUND OF THE INVENTION

1. Field of the Invention

The present invention relates to a technology for suppressing toner adhesion to components in an image forming apparatus.

2. Description of the Related Art

An electrophotographic image is formed in such a manner that an electrostatic image is formed by irradiating laser beam or the like to a charged latent image carrier (photoreceptor), the pigment powder is transferred to the image carrier thereby exposing the electrostatic image, and an exposed image is transferred on a transfer material and then fixed by applying heat or pressure.

In this type of image forming process, toner or developer, which is a pigment powder, might adhere to a developing member in an image forming apparatus. Such adhesion can be removed or prevented by controlling a regulating blade pressure or changing toner characteristic values. However, in a new machine or a machine which has not been used for a long time, toner in a lower part of the accumulated toner is likely to be compressed by a weight of the toner and solidified before the toner is agitated. If the toner is solidified at a supplying member of the image forming apparatus before driving the image forming apparatus, the above measure is not sufficient to solve toner adhesion.

### SUMMARY OF THE INVENTION

It is an object of the present invention to at least partially solve the problems in the conventional technology.

According to an aspect of the present invention, there is provided a process cartridge configured to accommodate toner, the process cartridge that includes an agitating unit that agitates the toner; a developing roller that supplies the toner to an image carrier; and a driving system that drives the agitating unit and the developing roller, wherein when starting driving of the agitating unit and the developing roller, the driving system raises a rotation speed of one or both of the agitating unit and the developing roller in a stepwise manner until the agitating unit and the developing roller attain a steady rotation speed.

According to another aspect of the present invention, there is provided a process cartridge configured to accommodate toner, the process cartridge that includes an agitating unit that agitates the toner; a developing roller that supplies the toner to an image carrier; and a driving system that drives the agitating unit and the developing roller, wherein when stopping driving of the agitating unit and the developing roller, the driving system drops a rotation speed of one or both of the agitating unit and the developing roller in a stepwise manner from a steady rotation speed until completion of stop of the driving.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image forming apparatus according to an embodiment of the present invention;

FIG. 2 is a schematic diagram of a process cartridge shown in FIG. 1;

FIG. 3 is a schematic diagram of a toner supplying member including a toner remaining portion of the process cartridge shown in FIG. 2;

FIG. 4 is a front end view of a housing of a driving source of the image forming apparatus shown in FIG. 1;

FIG. 5 is a back end view of the housing shown in FIG. 4;

FIG. 6 is a schematic diagram of a gear drive train in the process cartridge shown in FIG. 2;

FIG. 7 is a graph of a relation between a motor rotation speed and time taken to reach a normal rotation speed at start of rotation of the toner supplying member shown in FIG. 2; and

FIG. 8 is a graph of a relation between a motor rotation speed and time at stop of rotation of the toner supplying member shown in FIG. 2.

### DETAILED DESCRIPTION OF THE PREFERRED EMBODIMENTS

Exemplary embodiments of the present invention are described in detail below with reference to the accompanying drawings.

FIG. 1 is a schematic diagram of a color laser printer 10, which is an example of an image forming apparatus, according to a first embodiment of the present invention. The printer 10 includes process cartridges 11K, 11M, 11C, 11Y (hereinafter, integrally described as “process cartridge 11” as appropriate), an exposing device 13, an intermediate transfer member 14, and a sheet feeding device 15. The process cartridges 11K, 11M, 11C, 11Y include photoreceptor drums 1K, 1M, 1C, 1Y rotating at a constant speed for each color of black (K), magenta (M), cyan (C), yellow (Y), developing rollers 4K, 4M, 4C, 4Y as developer carriers, toner bottles 7K, 7M, 7C, 7Y and other constituting mechanisms required for the electrophotographic process, respectively. The exposing device 13 writes image information onto the photoreceptor drums 1K, 1M, 1C, 1Y. The intermediate transfer member 14 holds color images developed by and superimposed from the photoreceptor drums 1K, 1M, 1C, 1Y, and includes an intermediate transfer belt 41 also serving as a feeding belt for a transfer material P, a driving roller 42 that drives transmission, and a supporting roller 43 around which the intermediate transfer belt is extended. The sheet feeding device 15 supplies the transfer material P from a sheet feed cassette 51 to a final transfer position of the intermediate transfer member 14. The printer 10 also includes a fixing device 16, a sheet discharge portion 17, a feeding device 18, and a double-side printing mechanism 19. The fixing device 16 fixes a color image transferred on the transfer material P. The sheet discharge portion 17 includes a discharge roller 71 that discharges the transfer material P after image fixation to a sheet receiving portion on the upper face of an apparatus housing of the printer 10. The feeding device 18 feeds the transfer material P supplied from the sheet feeding device 15. The double-side printing mechanism 19 forms an image on both sides of the transfer material P.

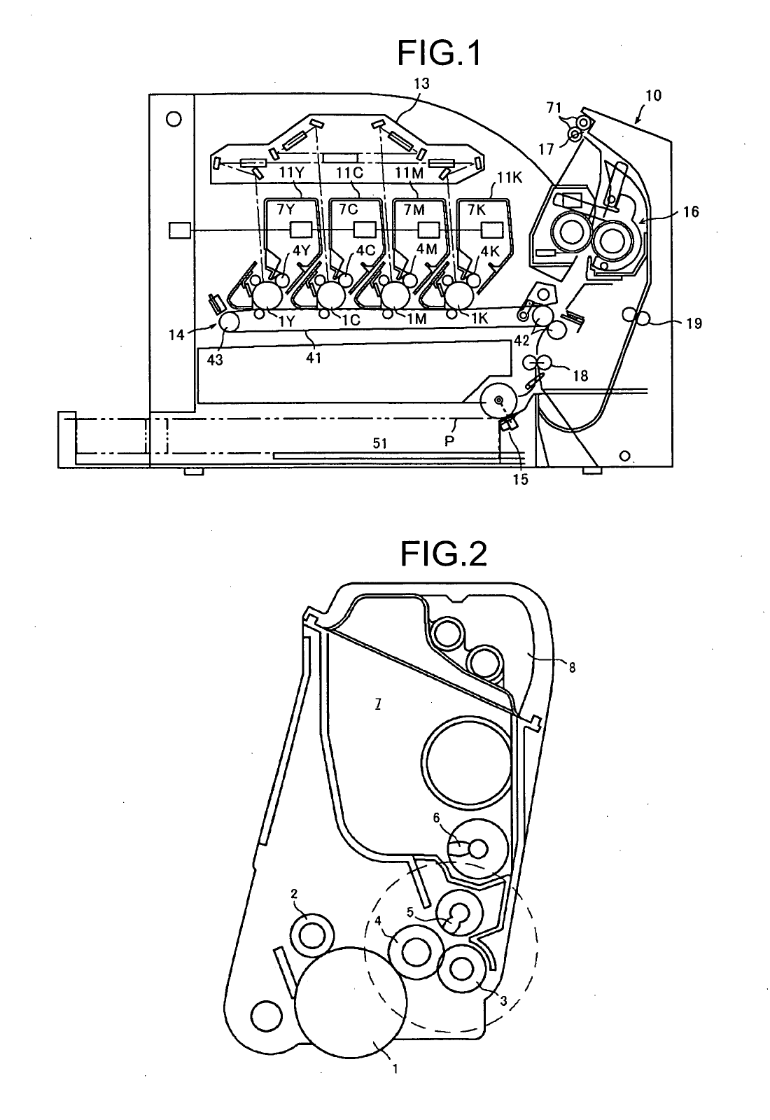

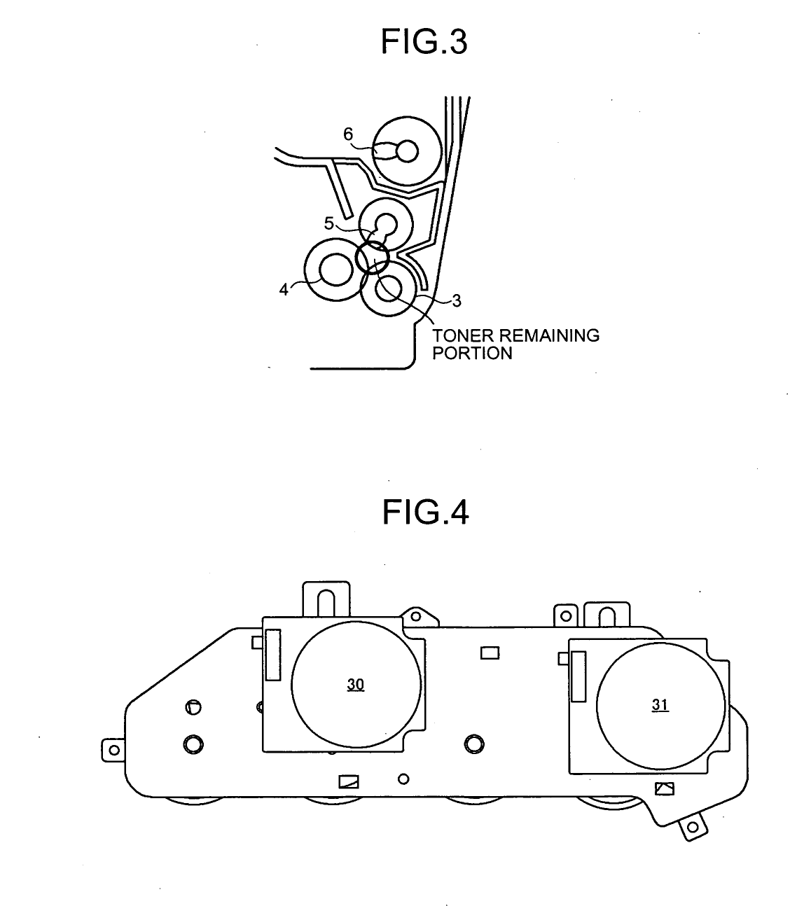

FIG. 2 is a schematic diagram of the process cartridge 11 serving as the image forming member. The image forming member integrally includes an image carrier (photoreceptor 1), a charging unit (charging roller 2) that evenly charges the surface of the image carrier, developing unit (supplying roller 3, developing roller 4, screw 5), and a developer supplying member (toner bottle 7 accommodating a paddle 6), and is formed as a toner cartridge. On top of the developer supplying member, a used-toner bottle 8 is also mounted. The image forming member is provided in each of units for each color of K, M, C, Y. FIG. 3 is a schematic diagram of a toner supplying member (circular region surrounded by a chain line in FIG. 2) in the image forming member. The toner supplying member includes the toner supplying roller 3, the developing roller 4, the screw 5, the paddle 6, and the toner bottle 7. With this configuration, toners are likely to remain in a region surrounded by a circle (toner remaining portion) in FIG. 3, and remained toners easily solidify. Such solidification of toners can be prevented by executing a counteracting operation at starting or stop of the printer 10.

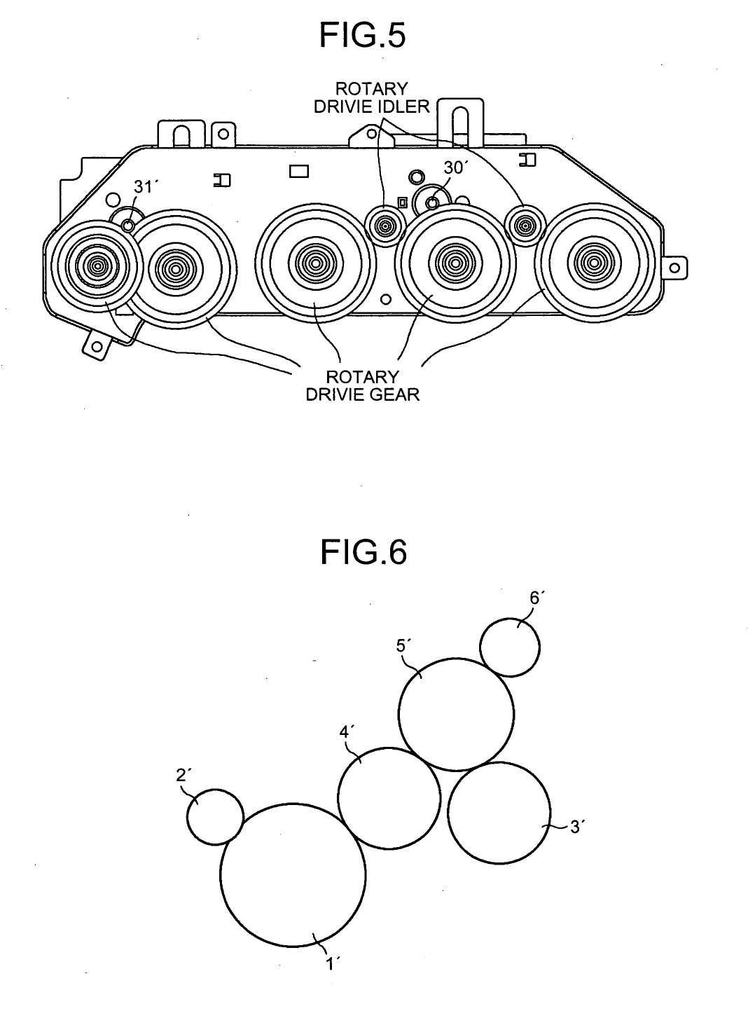

A driving transmission mechanism is provided coaxially with the photoreceptor 1 and rotated by,driving force obtained from a driving device (not shown). Configuration of the driving transmission mechanism is described referring to FIGS. 4 to 6. FIG. 4 is a front end view of a housing of driving sources 30, 31. The driving sources 30, 31 drive a gear train (rotary drive gear, rotary drive idler) shown in FIG. 5. FIG. 5 is a back end view of the housing shown in FIG. 4. A gear 1′ press-fitted into the photoreceptor 1 is first driven by a drive train driven by driving shafts 30′, 31′ of the driving sources 30, 31. FIG. 6 is a schematic diagram of a gear drive train in the process cartridge. The developing roller (developing roller gear 4′), a charging roller (charging roller gear 2′) are rotated by a gear 1′ press-fitted in the photoreceptor 1 in the gear drive train, and the screw (screw gear 5′), a supplying roller (supply roller gear 3′), the paddle (paddle gear 6′) are driven by the developing roller. For example, the circumferential velocities of the developing roller and the supplying roller are equal and they are rotated,in the same direction in opposite regions. A brushless motor is supposed for driving sources 10, 11 in FIG. 4, but a stepping motor can be also used.

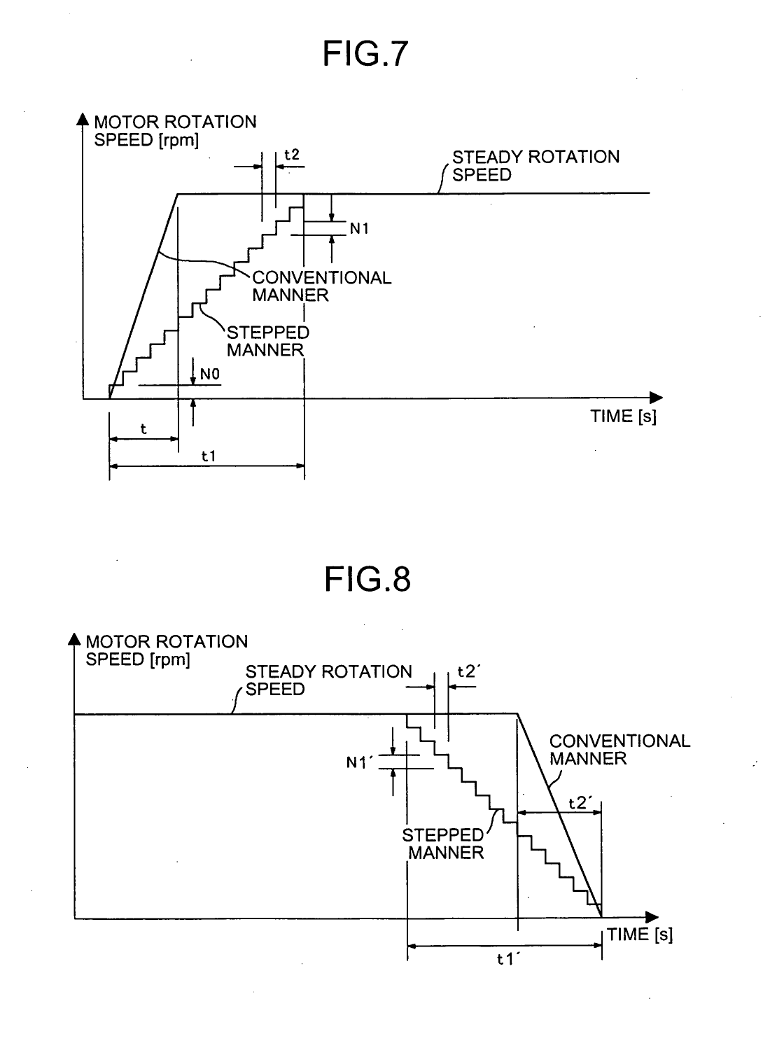

Driving control at the toner supplying member is described below. FIG. 7 is a graph of a relation between a motor rotation speed and time taken to reach a normal rotation speed when rotation of the toner supply portion is started. In the control at start of the rotation of the toner supplying member, the motor rotation speed is not raised to a steady rotation speed in a linear state but raised in a stepwise manner. By such a rising manner, the toner remaining portion can be unstiffened. When the stepping motor is used, the length of a step is made longer so that the rotation speed is raised more gradually. If a brushless motor is used, the rotation speed is first raised to a minimum guaranteed speed (N0 part in FIG. 7) and made stable, and then, the rotation speed is gradually raised. At this time, time t1 required to raise the motor rotation speed to the steady rotation speed is in a range of t1≧2×t, where a default rising time is t, time t2 of each interval is in a range of t2≦t1/10, and a step N1 of the rotation speed is in a range of N1≦N/10, where the steady rotation speed is N.

FIG. 8 is a graph of a relation between the motor rotation speed and time when the rotation of the toner supply portion is stopped. The motor rotation speed is not lowered to stop in the linear state at lowering (when the motor is stopped) but lowered in a stepwise manner. By such a lowering manner, remaining and solidification of the toner can be prevented. If the stepping motor is used, the length of a step is made longer so that the rotation speed is lowered more gradually. If the brushless motor is used, time t1′ required to lower till stop is in a range of t1′≧2×t′, where default lowering time is t′, time t2′ of each interval is in a range of t2′≦t1′/10, and a step N1′ of the rotation speed satisfies a condition of N1′≦N/10, where the steady rotation speed is N.

Table 1 and Table 2 are examples of relation between a time at the start of the motor, the length of the step, and occurrence of toner adhesion. 1K pieces of images are outputted in 2 by 2 in each color (K, M, C, Y).

TABLE 1

| | | Step [ms] | | | | | | | | |
|---|---|---|---|---|---|---|---|---|---|---|
| | | 20 | 30 | 40 | 50 | 60 | 70 | 80 | 90 | 100 |
| Rising | 1000 | ◯ | ◯ | ◯ | ◯ | ◯ | ◯ | ◯ | ◯ | ◯ |
| time | 900 | ◯ | ◯ | ◯ | ◯ | ◯ | ◯ | ◯ | ◯ | Δ |
| [ms] | 800 | ◯ | ◯ | ◯ | ◯ | ◯ | ◯ | ◯ | Δ | Δ |
| | 700 | ◯ | ◯ | Δ | ◯ | Δ | ◯ | Δ | ◯ | Δ |
| | 600 | ◯ | Δ | ◯ | Δ | Δ | ◯ | ◯ | ◯ | Δ |
| | 500 | Δ | X | Δ | X | Δ | X | Δ | Δ | Δ |
| | 400 | Δ | Δ | X | Δ | X | Δ | X | Δ | X |
| | 300 | X | X | X | X | X | X | X | X | X |
| | 200 | X | X | X | X | X | X | X | X | X |

TABLE 2

| | | Step [ms] | | | | | | | | |
|---|---|---|---|---|---|---|---|---|---|---|
| | | 20 | 30 | 40 | 50 | 60 | 70 | 80 | 90 | 100 |
| Rising | 1000 | ◯ | ◯ | ◯ | ◯ | ◯ | ◯ | ◯ | ◯ | ◯ |
| time | 900 | ◯ | ◯ | ◯ | ◯ | ◯ | ◯ | ◯ | ◯ | Δ |
| [ms] | 800 | ◯ | ◯ | ◯ | ◯ | ◯ | ◯ | ◯ | Δ | Δ |
| | 700 | Δ | ◯ | Δ | ◯ | Δ | ◯ | Δ | ◯ | Δ |
| | 600 | Δ | Δ | Δ | Δ | Δ | ◯ | ◯ | X | Δ |
| | 500 | Δ | X | Δ | X | Δ | X | Δ | X | X |
| | 400 | Δ | Δ | X | Δ | X | Δ | X | Δ | X |
| | 300 | X | X | X | X | X | X | X | X | X |
| | 200 | X | X | X | X | X | X | X | X | X |

Circle: Image with vertical white streak by toner adhesion has not occurred.
Triangle: 1 to 3 images with vertical white streaks by toner adhesion occurred.
Cross: More than 3 images with vertical white streaks by toner adhesion occurred.
Painted: Default

According to an aspect of the present invention, toner which has been solidified or is being solidified is unstiffened, so that a bulk of toner is not pushed onto the developing member in an image forming apparatus. Therefore, toner adhesion can be prevented. Moreover, the toner is not suddenly pushed onto the developing member; and thereby toner adhesion can be prevented.

Furthermore, according to another aspect of the present invention, toner adhesion can be prevented more assuredly by defining a condition of time to rise a rotation speed of rollers to a steady rotation speed, by defining a condition of a rising step, by defining a condition of time from the steady rotation speed to full stop, or by defining a condition of a lowering step,. It is preferable, from the viewpoint of prevention of toner adhesion, to employ a stepping motor or a brushless motor as a driving source of a driving system of the image forming apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A process cartridge configured to accommodate toner, the process cartridge comprising:
an agitating unit that agitates the toner;
a developing roller that supplies the toner to an image carrier; and
a driving system that drives the agitating unit and the developing roller, wherein
when starting driving of the agitating unit and the developing roller, the driving system raises a rotation speed of one or both of the agitating unit and the developing roller in a stepwise manner until the agitating unit and the developing roller attain a steady rotation speed.

2. The process cartridge according to claim 1, wherein time t1 taken to rise the rotation speed to the steady rotation speed is twice or more of a predetermined rising time.

3. The process cartridge according to claim 2, wherein time t2 of each time interval at a rising of the rotation speed in a stepwise manner is in a range of t2≦t1/10, and a rising speed for each interval is 1/10 or less of the steady rotation speed.

4. The process cartridge according to claim 1, wherein the driving source in the driving system is a stepping motor.

5. The process cartridge according to claim 1, wherein the driving source in the driving system is a brushless motor.

6. An image forming apparatus comprising the process cartridge according to claim 1.

7. An image forming apparatus comprising a plurality of the process cartridges according to claim 1 for four colors of black, magenta, cyan, and yellow, respectively.

8. The image forming apparatus according to claim 7, wherein the process cartridge for black and a transferring unit are driven by a first driving source, and the process cartridges for magenta, cyan, and yellow are driven by a second driving source.

9. A process cartridge configured to accommodate toner, the process cartridge comprising:
an agitating unit that agitates the toner;
a developing roller that supplies the toner to an image carrier; and
a driving system that drives the agitating unit and the developing roller, wherein
when stopping driving of the agitating unit and the developing roller, the driving system drops a rotation speed of one or both of the agitating unit and the developing roller in a stepwise manner from a steady rotation speed until completion of stop of the driving.

10. The process cartridge according to claim 9, wherein time t1 from the steady rotation speed to completion of stop of the rotation is twice or more of a predetermined lowering time.

11. The process cartridge according to claim 10, wherein time t2 of each interval at a lowering of the rotation speed in a stepwise manner is in a range of t2≦t1/10, and a lowering speed for each interval is 1/10 or less of the steady rotation speed.

12. The process cartridge according to claim 9, wherein the driving source in the driving system is a stepping motor.

13. The process cartridge according to claim 9, wherein the driving source in the driving system is a brushless motor.

14. An image forming apparatus comprising the process cartridge according to claim 9.

15. An image forming apparatus comprising a plurality of the process cartridges according to claim 9 for four colors of black, magenta, cyan, and yellow, respectively.

16. The image forming apparatus according to claim 15, wherein the process cartridge for black and a transferring unit are driven by a first driving source, and the process cartridges for magenta, cyan, and yellow are driven by a second driving source.
